(19) United States
(12) Patent Application Publication
(10) Pub. No.: US 2016/0073437 A1
(43) Pub. Date: Mar. 10, 2016

(54) RADIO COMMUNICATION DEVICE AND METHOD FOR TRANSMITTING DATA

(71) Applicant: Intel Corporation, Santa Clara, CA (US)

(72) Inventors: Sudhanshu John, Beaverton, OR (US); Gang Shen, Hillsboro, OR (US)

(21) Appl. No.: 14/477,967

(22) Filed: Sep. 5, 2014

(51) Int. Cl. H04W 76/02; H04W 4/00; H04W 4/02; H04M 1/725

(52) U.S. Cl. CPC H04W 76/023; H04M 1/7253; H04W 4/008; H04W 4/026

(57) ABSTRACT

A radio communication device is described comprising a circuit configured to determine a presence of a plurality of peripheral devices in a communication range with the radio communication device, a circuit configured to determine a respective orientation of a predefined portion of the radio communication device to each of the determined peripheral devices, a circuit configured to select at least one peripheral device of the plurality of determined peripheral devices based on the determined orientations, a circuit configured to establish a radio connection with the selected peripheral device.

### TECHNICAL FIELD

Embodiments described herein generally relate to radio communication devices and methods for transmitting data.

### BACKGROUND

A radio communication device such as a smart phone may transmit output data to a wirelessly connected peripheral output device, e.g. export its display or output sound via an external, wirelessly connected loudspeaker. Since a plurality of output peripheral devices may be present in the vicinity of the communication device, mechanisms that allow a convenient selection of a suitable output peripheral device are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a radio communication device.

FIG. 2 shows a flow diagram illustrating a method for transmitting data.

FIG. 3 shows a radio communication arrangement.

FIG. 4 illustrates a data transmission applying beamforming between a client device and a display adapter.

FIG. 5 shows a transmission flow diagram illustrating a channel sounding process.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

A connection to export the display of a radio communication device to a peripheral device based on technologies like Wifi Direct and Wireless Display is typically based on user interaction, information parsing about adapter statistics and availability of a session with the other communication device (e.g. the Wireless Display adapter). For example, a user is required to scan, find and select a display by adapter name, which is not intuitive and takes quite a long time to connect and display the content user wants to share/display.

In contrast, in the following, a radio communication device is described that provides a user with a “Point and Shoot” like connection scenario, in particular in a scenario with a wireless display infrastructure including communication devices and peripheral devices that have a small form factor (e.g. Smart Phones, Tablets, Cameras and Portable picture frames etc.).

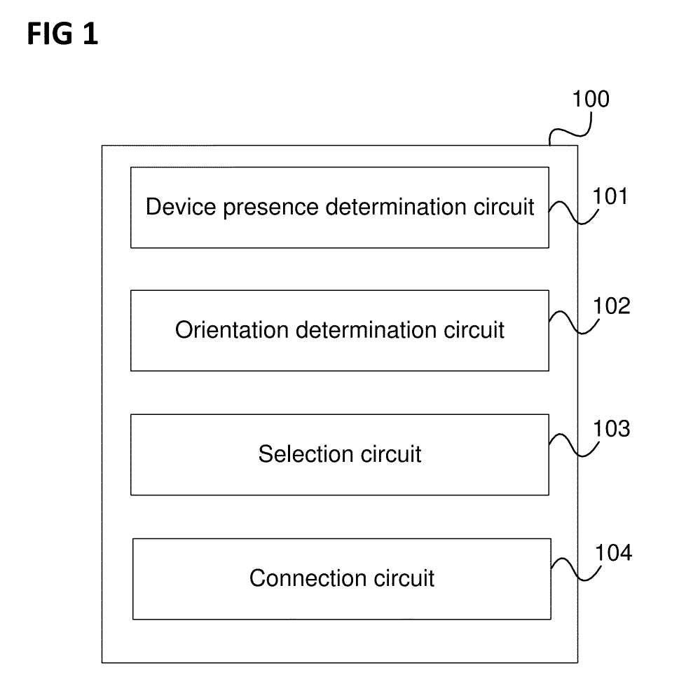

FIG. 1 shows a radio communication device 100.

The radio communication device 100 includes a device presence determination circuit 101 configured to determine a presence of a plurality of peripheral devices in a communication range with the radio communication device.

Further, the radio communication device 100 includes an orientation determination circuit 102 configured to determine a respective orientation of a predefined portion of the radio communication device to each of the determined peripheral devices.

The radio communication device 100 further includes a selection circuit 103 configured to select at least one peripheral device of the plurality of determined peripheral devices based on the determined orientations.

Further, the radio communication device 100 includes a connection circuit 104 configured to establish a radio connection with the selected at least one peripheral device. The radio communication device 100 may further include a transmitter (not shown in FIG. 1) configured to transmit data to the selected at least one peripheral device.

In other words, a radio communication device allows a user to select a target peripheral device for data transmission (e.g. an output device like a display or a printer) from a plurality of (present) candidate devices by pointing the radio communication device in the direction of the target peripheral device. Thus, the user experience may be extended to allow a connection to a target peripheral device and/or a switch between available candidate peripheral devices, e.g. devices to which the radio communication device's display is exported (e.g. Wireless Display devices), in a “Point and Shoot” way, e.g. by pointing a certain side of the communication device, such as the backside, in the direction of the peripheral device to be selected.

A peripheral device may be understood as a computer peripheral including an input, output and/or storage peripheral such as a scanner, a copier, a printer and/or fax machine (e.g. supporting WLAN), a Wireless Display Receiver, a Wireless Access Point, a TV (e.g. with WLAN receiver a thermostat, an alarm system, a wireless camera or a Wireless Audio Receiver and possibly also a mobile phone or a tablet (e.g. with WLAN support) which acts as peripheral device (e.g. as input, output or storage device) for the radio communication device.

The peripheral devices whose present is detected and from among are selected are for example devices in the vicinity of the radio communication device, e.g. within near-field communication range of the radio communication device (or at least in viewing or walking distance of the radio communication device, e.g. in the same room as the radio communication device). For example, the best possible display available in vicinity of the radio communication device to display content may be discovered and located and the decision may be applied to automatically connect or switch displays.

For example, the radio communication device may use channel estimation and RSSI values as statistical parameters to deduce the directions of the candidate displays, select a display based on the directions and thereafter apply the decision to connect to the selected display adapter.

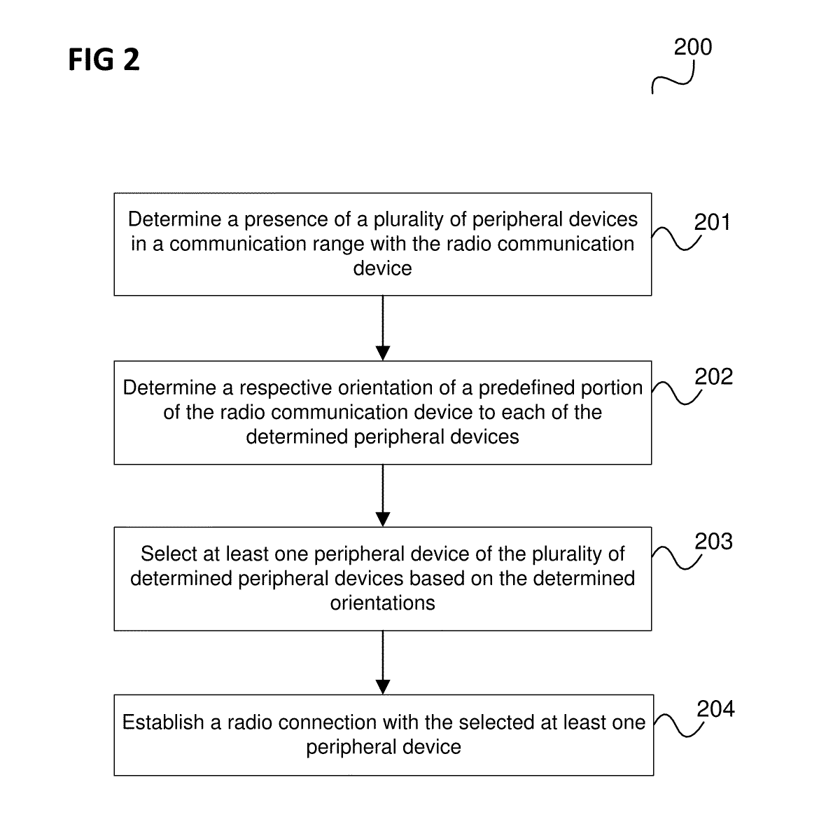

The radio communication device 100 for example carries out a method as illustrated in FIG. 2.

FIG. 2 shows a flow diagram 200 illustrating a method for transmitting data, for example carried out by a radio communication device.

In 201, the radio communication device determines a presence of a plurality of peripheral devices in a communication range with the radio communication device.

In 202, the radio communication device determines a respective orientation of a predefined portion of the radio communication device to each of the determined peripheral devices.

In 203, the radio communication device selects at least one peripheral device of the plurality of peripheral communication devices based on the determined orientations.

In 204, the radio communication device establishes a radio connection with the selected at least one peripheral device.

Furthermore, the radio communication device may transmit data to the selected at least one peripheral device.

The following examples pertain to further embodiments.

Example 1, as described with reference to FIG. 1, is a radio communication device comprising: a device presence determination circuit configured to determine a presence of a plurality of peripheral devices in a communication range with the radio communication device; an orientation determination circuit configured to determine a respective orientation of a predefined portion of the radio communication device to each of the determined peripheral devices; a selection circuit configured to select at least one peripheral device of the plurality of determined peripheral devices based on the determined orientations; and a connection circuit configured to establish a radio connection with the selected at least one peripheral device.

In Example 2, the subject matter of Example 1 can optionally include: a transmitter configured to transmit data to the selected at least one peripheral device.

In Example 3, the subject matter of any one of Examples 1-2 can optionally include: a channel quality determination circuit configured to determine, for each of the determined peripheral devices, a quality of a communication channel between the radio communication device and the determined peripheral devices.

In Example 4, the subject matter of any one of Examples 1-3 can optionally include that the orientation determination circuit is configured to determine a respective orientation of a predefined portion of the radio communication device to each of the determined peripheral devices based on the determined qualities.

In Example 5, the subject matter of Example 3 can optionally include that the selection circuit is further configured to select the at least one peripheral device based on the determined qualities.

In Example 6, the subject matter of Example 3 can optionally include that the selection circuit is further configured to select the at least one peripheral device based on a comparison of the determined qualities.

In Example 7, the subject matter of any one of Examples 1-6 can optionally include that the data is output data of the radio communication device.

In Example 8, the subject matter of any one of Examples 1-7 can optionally include that the data is display data of the radio communication device.

In Example 9, the subject matter of any one of Examples 1-8 can optionally include that the data is audio output data of the radio communication device.

In Example 10, the subject matter of any one of Examples 1-9 can optionally include: a receiver configured to receive a signal from each of the determined peripheral devices, wherein the orientation determination circuit is configured to determine the respective orientation of a predefined portion of the radio communication device to each of the determined peripheral devices based on angle of arrival information of signals transmitted by the determined peripheral devices to the radio communication device.

In Example 1 the subject matter of Example 10 can optionally include: a plurality of receive antennas and an angle of arrival determining circuit configured to determine the angle of arrival information based on the signals received by the plurality of receive antennas from the determined peripheral devices.

In Example 12, the subject matter of Example 2 can optionally include that the transmitter comprises a plurality of transmit antennas and is configured to transmit the data to the selected at least one peripheral device by beamforming.

In Example 13, the subject matter of Example 12 can optionally include that the transmitter is configured to determine antenna gains for the beamforming based on signals received from the selected at least one peripheral device.

In Example 14, the subject matter of any one of Examples 1-13 can optionally include that the predefined portion is a predefined side of the radio communication device.

In Example 15, the subject matter of any one of Examples 1-14 can optionally include that the predefined portion is a backside of the radio communication device.

In Example 16, the subject matter of any one of Examples 1-15 can optionally include that the device presence determination circuit is configured to determine a presence of a plurality of peripheral devices in a near-field communication range with the radio communication device.

In Example 17, the subject matter of any one of Examples 1-16 can optionally include that the device presence determination circuit is configured to determine a presence of a plurality of peripheral devices in a Bluetooth range with the radio communication device or within the same wireless local area network as the radio communication device.

Example 18, as described with reference to FIG. 2, is a method for transmitting data from a radio communication device comprising: determining a presence of a plurality of peripheral devices in a communication range with the radio communication device; determining a respective orientation of a predefined portion of the radio communication device to each of the determined peripheral devices; selecting at least one communication device of the plurality of determined peripheral devices based on the determined orientations; establishing a radio connection with the selected at least one peripheral device; and transmitting data to the selected at least one peripheral device.

In Example 19, the subject matter of Example 18 can optionally include: transmitting data to the selected at least one peripheral device.

In Example 20, the subject matter of any one of Examples 18-19 can optionally include: determining, for each of the determined peripheral devices, a quality of a communication channel between the radio communication device and the determined peripheral devices.

In Example 21, the subject matter of any one of Examples 18-20 can optionally include: determining a respective orientation of a predefined portion of the radio communication device to each of the determined peripheral devices based on the determined qualities.

In Example 22, the subject matter of any one of Examples 18-20 can optionally include: selecting the at least one peripheral device based on the determined qualities.

In Example 23, the subject matter of Example 20 can optionally include: selecting the at least one peripheral device based on a comparison of the determined qualities.

In Example 24, the subject matter of any one of Examples 18-23 can optionally include that the data is output data of the radio communication device.

In Example 25, the subject matter of any one of Examples 18-24 can optionally include that the data is display data of the radio communication device.

In Example 26, the subject matter of any one of Examples 18-25 can optionally include that the data is audio output data of the radio communication device.

In Example 27, the subject matter of any one of Examples 18-26 can optionally include: receiving a signal from each of the determined peripheral devices, wherein the orientation determination circuit is configured to determine the respective orientation of a predefined portion of the radio communication device to each of the determined peripheral devices based on angle of arrival information of signals transmitted by the determined peripheral devices to the radio communication device.

In Example 28, the subject matter of Example 27 can optionally include: determining the angle of arrival information based on the signals received by a plurality of receive antennas from the determined peripheral devices.

In Example 29, the subject matter of Example 19 can optionally include: transmitting the data to the selected at least one peripheral device by beamforming.

In Example 30, the subject matter of Example 19 can optionally include: determining antenna gains for the beamforming based on signals received from the selected at least one peripheral device.

In Example 31, the subject matter of any one of Examples 18-30 can optionally include that the predefined portion is a predefined side of the radio communication device.

In Example 32, the subject matter of any one of Examples 18-31 can optionally include that the predefined portion is a backside of the radio communication device.

In Example 33, the subject matter of any one of Examples 18-32 can optionally include: determining a presence of a plurality of peripheral devices in a near-field communication range with the radio communication device.

In Example 34, the subject matter of any one of Examples 18-33 can optionally include: determining a presence of a plurality of peripheral devices in a Bluetooth range with the radio communication device or within the same wireless local area network as the radio communication device.

Example 35 is a radio communication device comprising: a device presence determination means for determining a presence of a plurality of peripheral devices in a communication range with the radio communication device; an orientation determination means for determining a respective orientation of a predefined portion of the radio communication device to each of the determined peripheral devices; a selection means for selecting at least one peripheral device of the plurality of determined peripheral devices based on the determined orientations; and a connection means for establishing a radio connection with the selected at least one peripheral device.

In Example 36, the subject matter of Example 35 can optionally include: a transmitter means for transmitting data to the selected at least one peripheral device.

In Example 37, the subject matter of any one of Examples 35-36 can optionally include: a channel quality determination means for determining, for each of the determined peripheral devices, a quality of a communication channel between the radio communication device and the determined peripheral devices.

In Example 38, the subject matter of Example 37 can optionally include that the orientation determination means is for determining a respective orientation of a predefined portion of the radio communication device to each of the determined peripheral devices based on the determined qualities.

In Example 39, the subject matter of Example 37 can optionally include that the selection means is further for selecting the at least one peripheral device based on the determined qualities.

In Example 40, the subject matter of Example 37 can optionally include that the selection means is further for selecting the at least one peripheral device based on a comparison of the determined qualities.

In Example 41, the subject matter of any one of Examples 35-40 can optionally include that the data is output data of the radio communication device.

In Example 42, the subject matter of any one of Examples 35-41 can optionally include that the data is display data of the radio communication device.

In Example 43, the subject matter of any one of Examples 35-42 can optionally include that the data is audio output data of the radio communication device.

In Example 44, the subject matter of any one of Examples 35-43 can optionally include: a receiver means for receiving a signal from each of the determined peripheral devices, wherein the orientation determination means is for determining the respective orientation of a predefined portion of the radio communication device to each of the determined peripheral devices based on angle of arrival information of signals transmitted by the determined peripheral devices to the radio communication device.

In Example 45, the subject matter of Example 44 can optionally include: a plurality of receive antenna means and an angle of arrival determining means for determining the angle of arrival information based on the signals received by the plurality of receive antenna means from the determined peripheral devices.

In Example 46, the subject matter of Example 36 can optionally include that the transmitter means comprises a plurality of transmit antenna means and is for transmitting the data to the selected at least one peripheral device by beamforming.

In Example 47, the subject matter of Example 46 can optionally include that the transmitter means is for determining antenna gains for the beamforming based on signals received from the selected at least one peripheral device.

In Example 48, the subject matter of any one of Examples 35-47 can optionally include that the predefined portion is a predefined side of the radio communication device.

In Example 49, the subject matter of any one of Examples 35-48 can optionally include that the predefined portion is a backside of the radio communication device.

In Example 50, the subject matter of any one of Examples 35-49 can optionally include that the device presence determination means is for determining a presence of a plurality of peripheral devices in a near-field communication range with the radio communication device.

In Example 51, the subject matter of any one of Examples 35-50 can optionally include that the device presence determination means is for determining a presence of a plurality of peripheral devices in a Bluetooth range with the radio communication device or within the same wireless local area network as the radio communication device.

Example 52 is a computer readable medium having recorded instructions thereon which, when executed by a processor, make the processor perform a method for performing radio communication from a radio communication device, the method comprising: determining a presence of a plurality of peripheral devices in a communication range with the radio communication device; determining a respective orientation of a predefined portion of the radio communication device to each of the determined peripheral devices; selecting at least one communication device of the plurality of determined peripheral devices based on the determined orientations; establishing a radio connection with the selected at least one peripheral device; and transmitting data to the selected at least one peripheral device.

In Example 53, the subject matter of Example 52 can optionally include recorded instructions thereon which, when executed by a processor, make the processor perform: transmitting data to the selected at least one peripheral device.

In Example 54, the subject matter of any one of Examples 52-53 can optionally include recorded instructions thereon which, when executed by a processor, make the processor perform: determining, for each of the determined peripheral devices, a quality of a communication channel between the radio communication device and the determined peripheral devices.

In Example 55, the subject matter of Example 54 can optionally include recorded instructions thereon which, when executed by a processor, make the processor perform: determining a respective orientation of a predefined portion of the radio communication device to each of the determined peripheral devices based on the determined qualities.

In Example 56, the subject matter of Example 54 can optionally include recorded instructions thereon which, when executed by a processor, make the processor perform: selecting the at least one peripheral device based on the determined qualities.

In Example 57, the subject matter of Example 54 can optionally include recorded instructions thereon which, when executed by a processor, make the processor perform: selecting the at least one peripheral device based on a comparison of the determined qualities.

In Example 58, the subject matter of any one of Examples 52-57 can optionally include that the data is output data of the radio communication device.

In Example 59, the subject matter of any one of Examples 52-58 can optionally include that the data is display data of the radio communication device.

In Example 60, the subject matter of any one of Examples 52-59 can optionally include that the data is audio output data of the radio communication device.

In Example 61, the subject matter of any one of Examples 52-60 can optionally include recorded instructions thereon which, when executed by a processor, make the processor perform: receiving a signal from each of the determined peripheral devices, wherein the orientation determination circuit is configured to determine the respective orientation of a predefined portion of the radio communication device to each of the determined peripheral devices based on angle of arrival information of signals transmitted by the determined peripheral devices to the radio communication device.

In Example 62, the subject matter of Example 61 can optionally include recorded instructions thereon which, when executed by a processor, make the processor perform: determining the angle of arrival information based on the signals received by a plurality of receive antennas from the determined peripheral devices.

In Example 63, the subject matter of Example 53 can optionally include recorded instructions thereon which, when executed by a processor, make the processor perform: transmitting the data to the selected at least one peripheral device by beamforming.

In Example 64, the subject matter of Example 53 can optionally include recorded instructions thereon which, when executed by a processor, make the processor perform: determining antenna gains for the beamforming based on signals received from the selected at least one peripheral device.

In Example 65, the subject matter of any one of Examples 52-64 can optionally include that the predefined portion is a predefined side of the radio communication device.

In Example 66, the subject matter of any one of Examples 52-65 can optionally include that the predefined portion is a backside of the radio communication device.

In Example 67, the subject matter of any one of Examples 52-66 can optionally include: determining a presence of a plurality of peripheral devices in a near-field communication range with the radio communication device.

In Example 68, the subject matter of any one of Examples 52-67 can optionally include recorded instructions thereon which, when executed by a processor, make the processor perform: determining a presence of a plurality of peripheral devices in a Bluetooth range with the radio communication device or within the same wireless local area network as the radio communication device.

It should be noted that one or more of the features of any of the examples above may be combined with any one of the other examples.

In the following, examples are described in more detail.

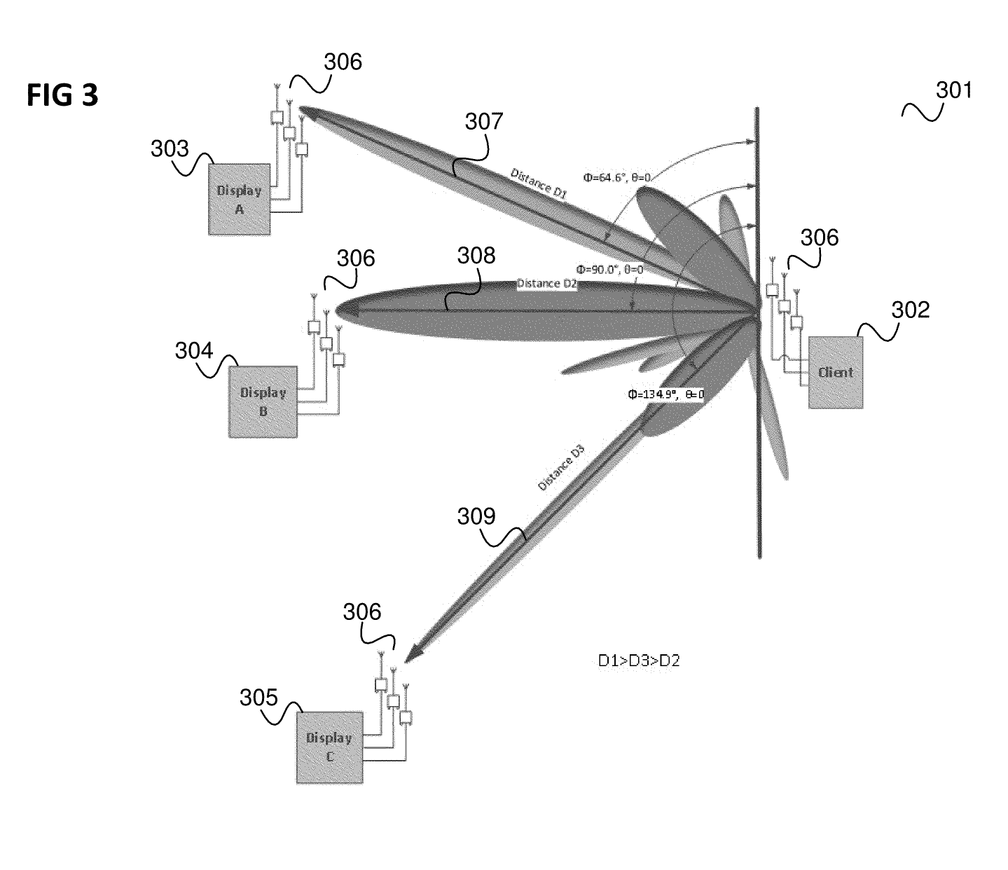

FIG. 3 shows a radio communication arrangement 301.

The radio communication arrangement 301 includes a client communication device 302 (e.g. corresponding to the radio communication device 100) and a plurality of other communication devices 303, 304, 305 (e.g. corresponding to the peripheral devices mentioned in context of FIG. 1) which are in this example devices having a display to which the client communication device's display may be exported. The other communication devices 303, 304, 305 are also referred to as display adapters or devices or just displays in the following and are denoted by A, B and C.

In this example, the client communication device 302 uses channel statistics such as the Channel State Information (CSI) and the Received Signal Strength Indicator (RSSI) to decide to which display adapter it establishes a connection for exporting its display (or to which display adapter it switches for display exporting). It should be noted that this may be typically implemented without hardware modification to typical Wireless Display devices or typical client devices.

In a communication system, e.g. a wireless local area network e.g. according to the 802.11n standard and the 802.11AC standard the following can for example be provided:
A display adapter selection can have a biased antenna gain in its favor if explicit beam forming is done in a Multi-User MIMO (multiple input multiple output) scenario and in a MIMO scenario
A display adapter can be allocated a budget of Tx (transmission) power to help improve the data transmission, e.g. the streaming experience. A better bandwidth will allow better quality of streamed video in terms of bitrate, resolution and frames per second.
A directional discovery of a display adapter can be performed in scenarios like home and office.
A connection to the display adapter can be performed based on further directional discovery and RSSI calculation.

In discovering the best available display adapter 303, 304, 305 in the region of interest (e.g. a home or office environment with multiple display devices) the client device 302 uses the channel state information to distinguish different display adapters 303, 304, 305 and their orientation and thereafter applies a decision on selecting the best available adapter 303, 304, 305 based on RSSI and region of selection.

The client 302 may use explicit beamforming based on channel state information (CSI) it for example deduces from a calibration and channel sounding procedure to achieve a higher antenna gain with respect to the selected display 303, 304, 305.

For example, the communication arrangement is a MIMO system, e.g. a 3×3 MIMO system where the client 302 and each of the display adapters 303, 304, 305 includes three antennas 306. In this case, the client 302 may determine the channel state information for each display adapter 303, 304, 305 (i.e. of the communication paths (channels) between the client 302 and the display adapter 303, 304, 305) utilizing the Long Training Field (LTF). It may calculate the RSSI for the channel using the SNR (signal to noise ratio) value of the channel.

In the following, examples for parameters (or statistics) are given based on which the client 302 may select the display adapter 303, 304, 305 to be used for outputting its display data (in other words display exporting), i.e. the most suitable (“best”) display adapter 303, 304, 305.

As illustrated in FIG. 3, it is assumed that there are three displays 303, 304, 305 among which the client 302 wants to discover the best for a connection, wherein all devices 302 to 305 are equipped for a 3×3 MIMO system.

Each display adapter 303, 304, 305 is in a certain direction 307, 308, 309 from the client device 302. Each direction 307, 308, 309 corresponds to angle of arrival statistics of signals from the respective display adapter 303, 304, 305 at the client device 302. The angle of arrival statistics for a display is given by a pair AOA_{display}(φ, θ), where φ is the azimuth angle and θ is the elevation angle.

The client 302 for example selects a display adapter 303, 304, 305 according to the following illustration:

$$Best Display at 3 \times 3 Receiver ( Client ) = \{ \begin{matrix}MAX \{ {RSSI}_{Display A} , {RSSI}_{Display B} , … {RSSI}_{Display N} \} \\ ∀ selected displays based on max RSSI value select \\ ↓ \\ MIN \{ {AOA}_{Display A}^{( ϕ , θ )} , {AOA}_{Display B}^{( ϕ , θ )} , … {AOA}_{Display N}^{( ϕ , θ )} \} \\ ↓ \\ select the display with Max RSSI and min AOA\end{matrix} \} \qquad ( 1 )$$

For example, the client 302 selects a display adapter 303, 304, 305 with a maximum RSSI and a minimum angle of arrival (for example in a least squares sense, or for example by minimizing a function having RSSI and angle of arrival as inputs.

In equation 6, like will be described below, SVD (Singular Value Decomposition) may provide a matrix V. The display may send this as feedback in sounding to client for calculating steering matrix Q.

For example, an optimized GR (Givens Rotation) may be used.

Angle parameters may be calculated as:

W= V̅_{(1:K)}={Πᵢ₌₁^{min(N}^{_{T-1}}^{,K)}[Dᵢ(1ᵢ₋₁e^{jφ}^{_{1,i}} . . . e^{jφ}^{_{N-1,i}})Πₗ₌ᵢ₊₁^{N}^{_{T}}Gₗᵢ^{T}(θₗᵢ)]×I_{N}_{_{T}}_{×K}} (2)

G may be defined as:

$${G}_{li}^{T} ( {θ}_{li} ) = [ \begin{matrix}{I}_{i - 1} & 0 & 0 & 0 & 0 \\ 0 & cos ( {θ}_{li} ) & 0 & sin ( {θ}_{li} ) & 0 \\ 0 & 0 & {I}_{l - i - 1} & 0 & 0 \\ 0 & - sin ( {θ}_{li} ) & 0 & cos ( {θ}_{li} ) & 0 \\ 0 & 0 & 0 & 0 & {I}_{{N}_{T} - 1}\end{matrix} ] \qquad ( 3 )$$

W may be fully represented in {φ, θ} and GR parameters may be represented as bits {b_{φ}, b_{θ}} which client may recover to create its beamforming matrix.

For example, for a constant elevation θ the client 302 selects a display adapter based on the maximum RSSI and the least azimuth angle (φ) (e.g. for a given measurement in time in a pairwise manner with respect to users).

It should be noted that in channel sounding the channel coherence time is typically long so no frequent sounding is needed. Further, if the display adapter is static frequent sounding is typically not needed.

For the following, a model for a point to point MU-MIMO and SU-MIMO system with N_{T} transmit and N_{R} receive antennas, e.g. in a typical indoor home/office environment as follows is used: The N_{T}×1 signal (i.e. the signal vector transmitted by N_{T} transmit antennas) is denoted as x and the N_{T}×N_{R} channel (characterizing the transmission between the N_{T} transmit and N_{R} receive antennas is denoted by H). The N_{R}×1 received signal (i.e. the signal received by N_{R} receive antennas) can be denoted by

y=Hx+n. (4)

For beamforming the MIMO channel H can be written as UDV^{H}

H=UDV^{H} (5)

where U is of size N_{R}×R, V is of size N_{T}×R are both unitary matrices and D is an R×R diagonal matrix containing singular values of H as a diagonal elements or rank R.

For example, the selected display 303, 304, 305 estimates the channel between itself and the client 320. It then determines the matrix V and feeds it back to the client 302 (acting as beamformer in this example).

Equation (5) can be rewritten as

H=UDΣ V̅^{H}=U D̅ V̅^{H} (6)

where

D̅=DΣ

and

Σ=diag[e^{{j*arg( v̅}^{^{H}}^{)}}]

wherein v̅^{H} represents the last column of V̅^{H}. The selected display may also feed back the matrix V̅ instead of V.

Accordingly, (5) can be written as

y=Hx+n=(U D̅ V̅^{H})x+n (7)

For transmitting the data to the selected display 303, 304, 305 in the first K Eigen modes (where K≦R) the client 302 may use the beamforming matrix

W= V̅_{(1:K)}

i.e. send the data as

x=Wu. (8)

The display can retrieve the data as

û=U^{H}y= D̅_{(1:K)}u+ñ (9)

wherein the noise vector ñ has same statistics as the noise vector n. This is the MIMO channel decoding of parallel sub-channels.

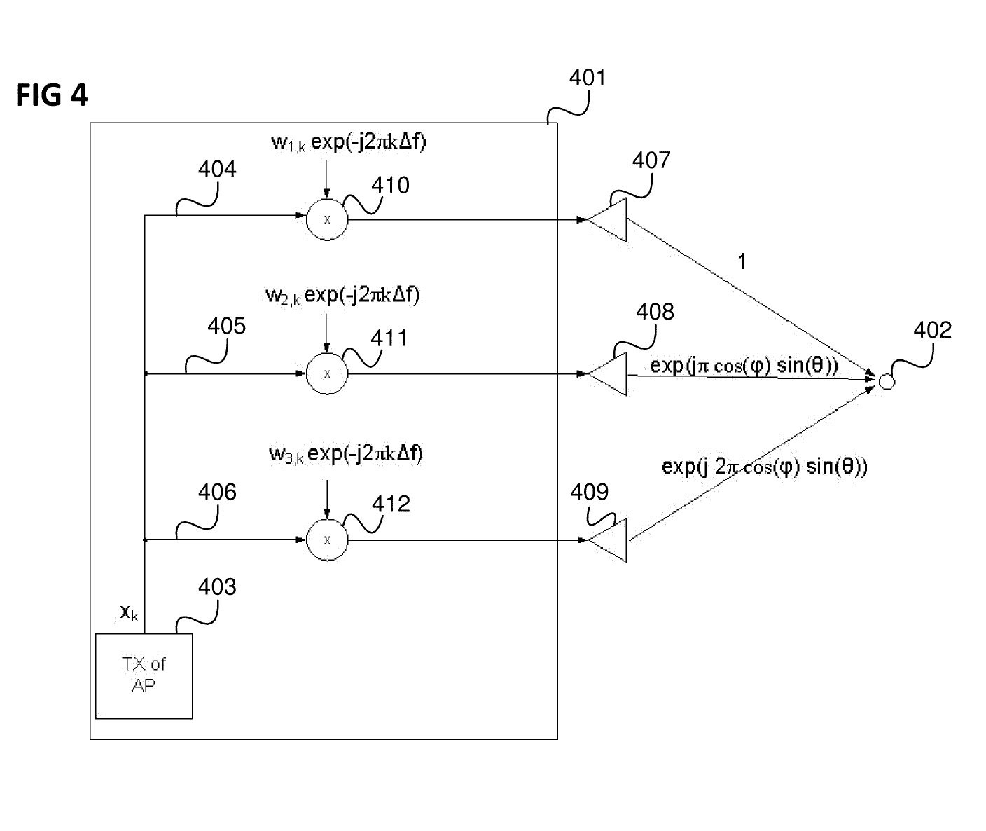

FIG. 4 illustrates a data transmission applying beamforming between a client device 401 and a display adapter 402.

The client device 401 corresponds to the client device 302 and the display adapter 402 corresponds to the selected display adapter 303, 304, 305.

The client device 401 includes a transmitter 403 which supplies the transmit vector (u in equation (8)) to each of three antenna paths 404, 405, 406. Each antenna path 404, 405, 406 is coupled to a respective transmit antenna 407, 408, 409. Further, each antenna path 404, 405, 406 includes a modulator 410, 411, 412 which weights the components of the transmit vector according to equation (8).

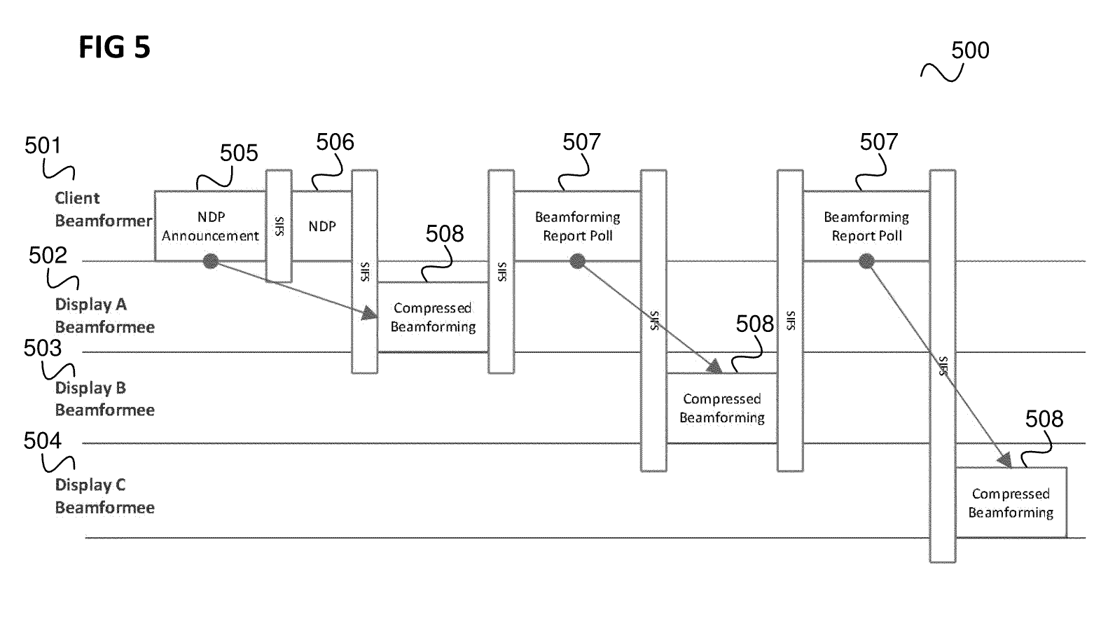

For a communication arrangement as illustrated in FIG. 3 channel sounding can be done per display in MU-MIMO basis or in SU-MIMO basis. The process of doing channel sounding either as MU-MIMO or SU-MIMO does typically not affect the results of the display selection. An example for a sounding process is given in FIG. 5.

FIG. 5 shows a transmission flow diagram 500.

The transmission flow is carried out between a client (beamformer) 501 corresponding to the client 302 and displays (beamformees) 502, 503, 504 corresponding to displays 303, 304, 305. The various transmissions are separated by SIFSs (short interframe spaces).

The beamformer (client) 501 begins the process by transmitting a Null Data Packet Announcement frame 505 which is used to gain control of the channel and identify the available displays. The beamformees 502, 503, 504 respond to the NDP Announcement 505 while all other stations defer channel access (e.g. access to common radio resources used for the communication) until the sounding sequence is complete.

The client 501 follows the NDP Announcement 505 with a null data packet 506. The value of the NDP 506 is such that the displays 502, 503, 504 can analyze the OFDM training fields to calculate the channel response (H), and therefore the steering matrix (Q). For multi-user transmissions, multiple NDPs may be transmitted.

Each display 502, 503, 504 analyzes the training fields in the received NDP and calculates a feedback matrix (V) and sends it to the client 501. The client 501 calculates the steering matrix (Q) utilizing the feedback matrix (V) from the displays 502, 503, 504. The relationships among the steering matrices deduced by the client 501 are such that Null steering can be achieved after sounding the channels.

The client may further perform beamforming report polling 507 after beamforming 508 for the displays 502, 503, 504.

Let the channel response between the client 501 and display A be H_{CLA}. For the power P_{CLA} radiated between client 501 and display A it holds that

$$Radiated Power {P}_{CLA} = \{ \begin{matrix}{Q}_{CLA} * {H}_{CLA} \neq ∅ \\ {Q}_{CLB} * {H}_{CLA} = ∅ \\ {Q}_{CLC} * {H}_{CLA} = ∅\end{matrix} \} \qquad ( 10 )$$

Let the channel response between the client 501 and display B be H_{CLB}. For the power P_{CLB} radiated between client 501 and display B it holds that

$$Radiated Power {P}_{CLB} = \{ \begin{matrix}{Q}_{CLA} * {H}_{CLB} \neq ∅ \\ {Q}_{CLB} * {H}_{CLB} = ∅ \\ {Q}_{CLC} * {H}_{CLB} = ∅\end{matrix} \} \qquad ( 11 )$$

Let the channel response between the client 501 and display C be H_{CLC}. For the power P_{CLC} radiated between client 501 and display C it holds that

$$Radiated Power {P}_{CLC} = \{ \begin{matrix}{Q}_{CLA} * {H}_{CLC} \neq ∅ \\ {Q}_{CLB} * {H}_{CLC} = ∅ \\ {Q}_{CLC} * {H}_{CLC} = ∅\end{matrix} \} \qquad ( 12 )$$

This may tell that the peak power is achieved only with correct steering matrix and channel response of the client display pair. The client channel response may maintain orthonormality with other displays steering matrix.

It will be understood that for example a peak power may be received for correct client and others may get nullified after proper sounding.

For example, in case of the decision statistic for the case depicted in FIG. 3

P_{CLA}<P_{CLC}<P_{CLB} (13)

For example, according to (1) the overall decision statistics for the region of interest (i.e. the candidate displays) finds display B to be best as the power received while doing sounding and angle of arrival estimation favor it to be best within the region of interest.

The client 302 may for example measure the CSI for each display device 303, 304, 305 by having each display device 303, 304, 305 in turn transmit a stream of 802.11n/ac packets, while all the other devices on the floor receive the packets. For example:
Packets are transmitted every few ms or portions of ms;
a few 1000s packets are transmitted;
CSI is measured from the long training field of each packet; and
3×3 CSI matrix is established.

Further, the received signal level data and noise level data may be captured and used to compute the received SNR.

For antenna gain calculation, for example
3×1 transmission beamforming weights are computed from the CSI for each of the receive antennas
computation is performed on each packet
the antenna gain is computed from weights as described with reference to FIG. 4
for computing statistics:
   antenna gain is computed over 360 deg azimuth and 90 deg elevation for each subcarrier
   the average antenna gain (linear) is computed over all subcarriers for each angle
   the maximum antenna gain is found over all angles
   this is repeated for each time instance and CDF (cumulative density function) formed
   antenna gain is reported at 50% and 90% probability point of the CDF (cumulative density function)

The components of the radio communication device (e.g. the various determines, the transmitter etc.) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A radio communication device comprising:
a device presence determination circuit configured to determine a presence of a plurality of peripheral devices in a communication range with the radio communication device;
an orientation determination circuit configured to determine a respective orientation of a predefined portion of the radio communication device to each of the determined peripheral devices;
a selection circuit configured to select at least one peripheral device of the plurality of determined peripheral devices based on the determined orientations; and
a connection circuit configured to establish a radio connection with the selected at least one peripheral device.

2. The radio communication device of claim 1, further comprising:
a transmitter configured to transmit data to the selected at least one peripheral device.

3. The radio communication device of claim 1, further comprising:
a channel quality determination circuit configured to determine, for each of the determined peripheral devices, a quality of a communication channel between the radio communication device and the determined peripheral devices.

4. The radio communication device of claim 3,
wherein the orientation determination circuit is configured to determine a respective orientation of a predefined portion of the radio communication device to each of the determined peripheral devices based on the determined qualities.

5. The radio communication device of claim 3,
wherein the selection circuit is further configured to select the at least one peripheral device based on the determined qualities.

6. The radio communication device of claim 3,
wherein the selection circuit is further configured to select the at least one peripheral device based on a comparison of the determined qualities.

7. The radio communication device of claim 1,
wherein the data is output data of the radio communication device.

8. The radio communication device of claim 1,
wherein the data is display data of the radio communication device.

9. The radio communication device of claim 1,
wherein the data is audio output data of the radio communication device.

10. The radio communication device of claim 1, further comprising:
a receiver configured to receive a signal from each of the determined peripheral devices, wherein the orientation determination circuit is configured to determine the respective orientation of a predefined portion of the radio communication device to each of the determined peripheral devices based on angle of arrival information of signals transmitted by the determined peripheral devices to the radio communication device.

11. The radio communication device of claim 10, further comprising:
a plurality of receive antennas and an angle of arrival determining circuit configured to determine the angle of arrival information based on the signals received by the plurality of receive antennas from the determined peripheral devices.

12. The radio communication device of claim 2,
wherein the transmitter comprises a plurality of transmit antennas and is configured to transmit the data to the selected at least one peripheral device by beamforming.

13. The radio communication device of claim 12,
wherein the transmitter is configured to determine antenna gains for the beamforming based on signals received from the selected at least one peripheral device.

14. The radio communication device of claim 1,
wherein the predefined portion is a predefined side of the radio communication device.

15. The radio communication device of claim 1,
wherein the predefined portion is a backside of the radio communication device.

16. The radio communication device of claim 1,
wherein the device presence determination circuit is configured to determine a presence of a plurality of peripheral devices in a near-field communication range with the radio communication device.

17. The radio communication device of claim 1,
wherein the device presence determination circuit is configured to determine a presence of a plurality of peripheral devices in a Bluetooth range with the radio communication device or within the same wireless local area network as the radio communication device.

18. A method for transmitting data from a radio communication device comprising:
determining a presence of a plurality of peripheral devices in a communication range with the radio communication device;
determining a respective orientation of a predefined portion of the radio communication device to each of the determined peripheral devices;
selecting at least one communication device of the plurality of determined peripheral devices based on the determined orientations;
establishing a radio connection with the selected at least one peripheral device; and
transmitting data to the selected at least one peripheral device.

19. The method of claim 18, further comprising:
transmitting data to the selected at least one peripheral device.

20. The method of claim 18, further comprising:
determining, for each of the determined peripheral devices, a quality of a communication channel between the radio communication device and the determined peripheral devices.

21. The method of claim 20, further comprising:
determining a respective orientation of a predefined portion of the radio communication device to each of the determined peripheral devices based on the determined qualities.

22. A computer readable medium having recorded instructions thereon which, when executed by a processor, make the processor perform a method for performing radio communication from a radio communication device, the method comprising:
determining a presence of a plurality of peripheral devices in a communication range with the radio communication device;
determining a respective orientation of a predefined portion of the radio communication device to each of the determined peripheral devices;
selecting at least one communication device of the plurality of determined peripheral devices based on the determined orientations;
establishing a radio connection with the selected at least one peripheral device; and
transmitting data to the selected at least one peripheral device.

23. The computer readable medium of claim 22, further having recorded instructions thereon which, when executed by a processor, make the processor perform:
transmitting data to the selected at least one peripheral device.

24. The computer readable medium of claim 22, further having recorded instructions thereon which, when executed by a processor, make the processor perform:
determining, for each of the determined peripheral devices, a quality of a communication channel between the radio communication device and the determined peripheral devices.

25. The computer readable medium of claim 24, further having recorded instructions thereon which, when executed by a processor, make the processor perform:
determining a respective orientation of a predefined portion of the radio communication device to each of the determined peripheral devices based on the determined qualities.
